(19) United States
(12) Patent Application Publication
(10) Pub. No.: US 2025/0205551 A1
(43) Pub. Date: Jun. 26, 2025

(54) SYSTEMS AND METHODS FOR PREDICTING CLUB PATH, FACE TO PATH AND FACE TO TARGET DURING GOLF SWING

(71) Applicant: GOLFTEC ENTERPRISES LLC, Englewood, CO (US)

(72) Inventor: Nick CLEARWATER, Englewood, CO (US)

(21) Appl. No.: 18/392,067

(22) Filed: Dec. 21, 2023

(51) Int. Cl. A63B 24/00; A63B 71/06; A63B 102/32; G06T 7/20

(52) U.S. Cl. CPC A63B 24/0021; A63B 24/0006; A63B 71/0622; G06T 7/20; A63B 2024/0012; A63B 2024/0031; A63B 2024/0056; A63B 2102/32; A63B 2220/05; A63B 2220/20; A63B 2220/35; A63B 2220/805; G06T 2207/30224; G06T 2207/30241

(57) ABSTRACT

Systems and methods are provided for predicting the club path, the face to path and the face to target of a golf club during a golf swing. Preferred embodiments include a sensing module executing code and configured to determine launch characteristics of a sport object upon being launched by the golf club. Preferred embodiments also include a trajectory module executing code and configured to record a plurality of golf swings, comprising at least a known club path, face to path and face to target value. The club path, the face to path and the face to target of the golf swing can then be predicted based on the launch characteristics and the recorded plurality of golf swings.

### TECHNICAL FIELD

The subject matter described herein relates to a device/method for determining golf swing characteristics and more specifically for determining the club path, face to path and face to target of a golf club after recording a golf swing using a launch monitor.

### BACKGROUND

Golf is a game that involves hitting a ball with a club. Numerous variables can be measured that describe the interaction between the club and the ball, particularly in relation to a target line defining which direction the golfer wishes to hit the ball. These measurements can be used to predict the trajectory of the golf ball and/or to advise the golfer on ways to improve their swing. Other variables can be derived from the measurements. Example variables include face angle, club path, and face to path during a golf swing.

Face Angle is an angle indicating the direction the club face is pointed, projected onto a horizontal plane, at the moment when the club face first makes contact with the ball. For example, for a right-handed golfer, a negative value indicates the club face is “closed,” or pointed toward the left of the target line, while a positive value indicated the club face is “open,” or pointed toward the right of the target line. A zero value indicates the club face is facing directly along the target line.

Club Path is an angle indicating the direction of movement of the center of the club head or center of gravity, projected onto a horizontal plane, at the moment when the golf ball is at maximum compression against the face of the golf club. For a right-handed golfer, negative values indicate divergence left of the target line and positive values indicate divergence right of the target line. A zero club path indicates the club is swung directly along the target line.

Face to path is an angle indicating the difference between face angle and club path. For a right-handed golfer, negative values indicate the face of the club is pointed to the left of the club path and positive values indicate the face of the club is pointed to the right of the club path. A zero face to path indicates the club is facing directly along the club path.

However, during a normal swing, the head of a golf club can travel in excess of 130 miles per hour or 4.9 centimeters per millisecond, and both the angle and the direction of movement of the club face can vary considerably over the course of the swing. Furthermore, from the time the club face first makes contact with the ball until the time the ball is launched (e.g., no longer in contact with the club face) can be less than 5 milliseconds, during which time the club may move up to 24 centimeters. This rapid sequence of events makes parameters such as club path and face to path difficult to measure at all, much less to compute with high accuracy and high precision in real time or near-real time. Accordingly, long-felt needs exist for improved means to determine club path and face to path, that address the forgoing and other concerns.

The information included in this Background section of the specification, including any references cited herein and any description or discussion thereof, is included for technical reference purposes only and is not to be regarded as subject matter by which the scope of the disclosure is to be bound.

### SUMMARY

Disclosed is a club path measurement system. The club path measurement system disclosed herein has particular, but not exclusive, utility for golf instruction and/or the simulation of a golf ball's trajectory based on its measurable launch characteristics.

The club path measurement system includes predicting at least one of a club path or a face to path of a golf club during a golf swing, which includes a sensing module executing code and configured to determine launch characteristics of a sport object, such as a golf ball, upon being launched by the golf club. The club path measurement system also includes a trajectory module executing code and configured to record a plurality of golf swings, comprising at least a known club path and face to path value. From this information, the club path measurement system can predict the club path and the face to path of the golf swing based on launch characteristics and recorded plurality of golf swings. In preferred embodiments, the trajectory module also calculates a D-plane for the golf club based on the launch characteristics, wherein a trajectory for the golf ball is determined based on the launch characteristics and the D-plane. In preferred embodiments, the club path measurement system also includes a launch monitor that provides images of the golf ball to the sensing module. The launch monitor, in preferred embodiments, includes an optical sensor and does not include a radar. The club measurement system incorporates a plurality of golf club types, including, but not limited to, a driver, a fairway metal or hybrid, an iron, and a wedge. The club measurement system also calculates a plurality of launch characteristics, including at least one of: Ball Speed; Club Head Speed; Launch Angle; Total Spin; Backspin; Side Spin; Carry; Total Distance; Offline; Descent Angle; Side Angle (azimuth); Peak Height; and Smash Factor.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the club path measurement system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a schematic, diagrammatic representation, in block diagram form, of at least a portion of an example club path measurement system, in accordance with at least one embodiment of the present disclosure.

FIG. 2 is a schematic, diagrammatic representation, in flow diagram form, of at least a portion of an example club path measurement method, in accordance with at least one embodiment of the present disclosure.

FIG. 3 is a schematic, diagrammatic representation, in block diagram form, of an example regression analysis training process, in accordance with at least one embodiment of the present disclosure.

FIG. 4 is a graph showing measured values of Face to Path on the X-axis vs. values predicted by the trained regression algorithm on the Y-axis for a driver type club, in accordance with at least one embodiment of the present disclosure.

FIG. 5 is a graph showing measured values of Club Path on the X-axis vs. values predicted by the trained regression algorithm on the Y-axis for a driver type club, in accordance with at least one embodiment of the present disclosure.

FIG. 6 is a graph showing measured values of Face to Path on the X-axis vs. values predicted by the trained regression algorithm on the Y-axis for an iron type club, in accordance with at least one embodiment of the present disclosure.

FIG. 7 is a graph showing measured values of Club Path on the X-axis vs. values predicted by the trained regression algorithm on the Y-axis for an iron type club, in accordance with at least one embodiment of the present disclosure.

FIG. 8 is a schematic, diagrammatic representation, in block diagram form, of at least a portion of an example club path measurement system, in accordance with at least one embodiment of the present disclosure.

FIG. 9 is a schematic diagram of a processor circuit, in accordance with at least one embodiment of the present disclosure.

### DETAILED DESCRIPTION

The present invention provides its benefits across a broad spectrum of endeavors. It is applicant's intent that this specification and the claims appended hereto be accorded a breadth in keeping with the scope and spirit of the invention being disclosed despite what might appear to be limiting language imposed by the requirements of referring to the specific examples disclosed. Thus, to acquaint persons skilled in the pertinent arts most closely related to the present invention, a preferred embodiment of the system is disclosed for the purpose of illustrating the nature of the invention. The exemplary method of installing, assembling and operating the system is described in detail according to the preferred embodiment, without attempting to describe all of the various forms and modifications in which the invention might be embodied. As such, the embodiments described herein are illustrative, and as will become apparent to those skilled in the art, can be modified in numerous ways within the scope and spirit of the invention, the invention being measured by the appended claims and not by the details of the specification.

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, subparagraph (f).

In accordance with at least one embodiment of the present disclosure, a club path measurement system is provided which provides accurate estimates, in real time or near-real time, of swing parameters that are difficult to measure and/or compute. A critical need in golf instruction includes being able to describe the motion of both the club head and the club face at impact. These two aspects of the swing are known as Club Path and Face to Path.

Club Path—The direction of the club head moving right or left at impact relative to the target line. This is often referred to as hitting a ball “out-to-in” or “in-to-out.”

Face to Path—the difference between the face angle at impact and the Club Path. For a right-handed golfer, a closed Face to Path would be negative, while an open face is positive.

Face to Target—the club path minus the face to path equals the face to target.

It is possible to predict Club Path and Face to Path using regression analysis of the data provided by a launch monitor (e.g., the GOLFTEC SkyTrak+), which photographically analyzes the impact of the golf club on the golf ball. For each golf swing, several initial conditions or flight parameters are recorded at ball impact, while others can be calculated from the measured values. These initial conditions or flight parameters can then serve as inputs to the trained regression model, which yields Club Path and Face to Path as outputs.

The present disclosure aids substantially in training golfers and in predicting the trajectories of golf balls, by improving real-time or near-real-time knowledge of the Club Path and Face to Path of each swing. Implemented on a launch monitor in communication with an external processor such as a smartphone, the club path measurement system disclosed herein provides practical improvements in golf instruction and simulation. This improved capability transforms a subjective judgment of Club Path and Face to Path into a rigorous, repeatable measurement, without the normally routine need to analyze slow-motion overhead video to measure these values directly. This unconventional approach improves the functioning of both the flight monitor's processor and the external processor, by enabling the calculation and reporting of additional parameters not previously available to a golfer, golf instructor, or golf simulation system.

The club path measurement system may be implemented as a process at least partially viewable on a display, and operated by a control process executing on a processor that accepts user inputs from a keyboard, mouse, or touchscreen interface, and that is in communication with one or more sensors. In that regard, the control process performs certain specific operations in response to different inputs or selections made at different times. Outputs of the club path measurement system may be printed, shown on a display, represented as audio outputs, or otherwise communicated to human operators. Certain structures, functions, and operations of the processor, display, sensors, and user input systems are known in the art, while others are recited herein to enable novel features or aspects of the present disclosure with particularity.

These descriptions are provided for exemplary purposes only, and should not be considered to limit the scope of the club path measurement system. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

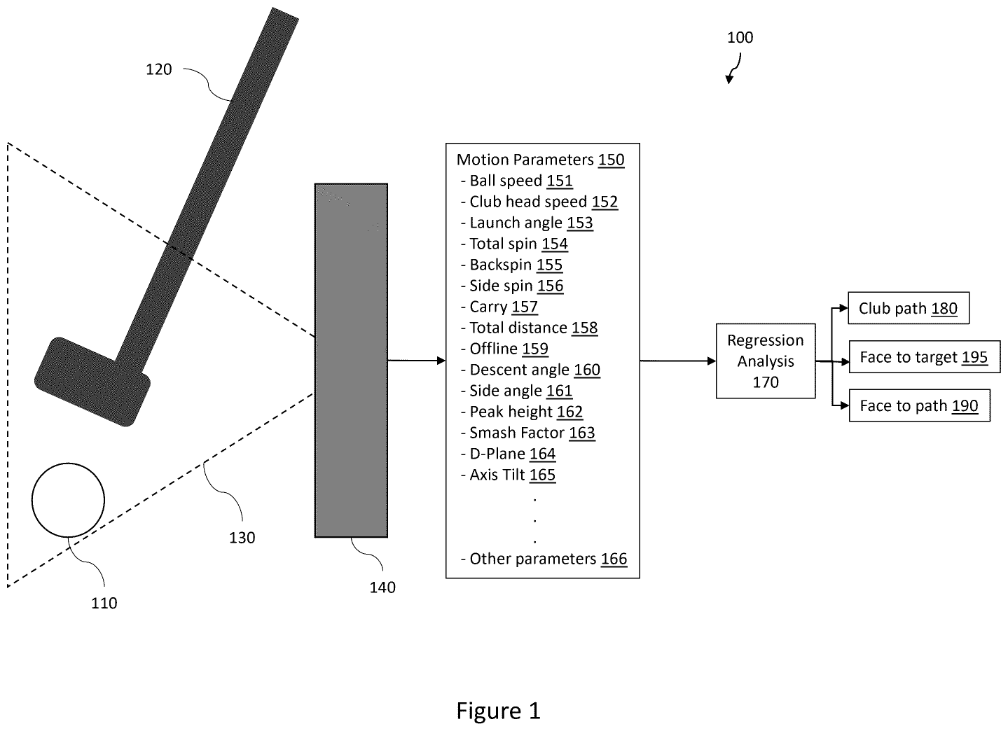

FIG. 1 is a schematic, diagrammatic representation, in block diagram form, of at least a portion of an example club path measurement system 100, in accordance with at least one embodiment of the present disclosure. Visible is a golf ball 110 being struck by a golf club 120 within the sensor viewing region 130 of a launch monitor 140.

As noted above, it is possible to predict Club Path and Face to Path using regression analysis of the data provided by the launch monitor 140 (e.g., a SkyTrak+). For each golf shot, several motion parameters 150 (otherwise known as initial conditions, flight parameters, launch characteristics, etc.) are recorded at ball impact by the launch monitor 140 (optionally in conjunction with an external processor as described below). These motion parameters 150 include: ball speed 151, club head speed 152, launch angle 153, total spin 154, backspin 155, side spin 156, carry 157, total distance 158, offline 159, descent angle 160, side angle or azimuth 161, peak height 162, smash factor 163 (e.g., ball speed/club speed), D-plane 164, axis tilt 165, and other parameters 166 as needed depending on the implementation.

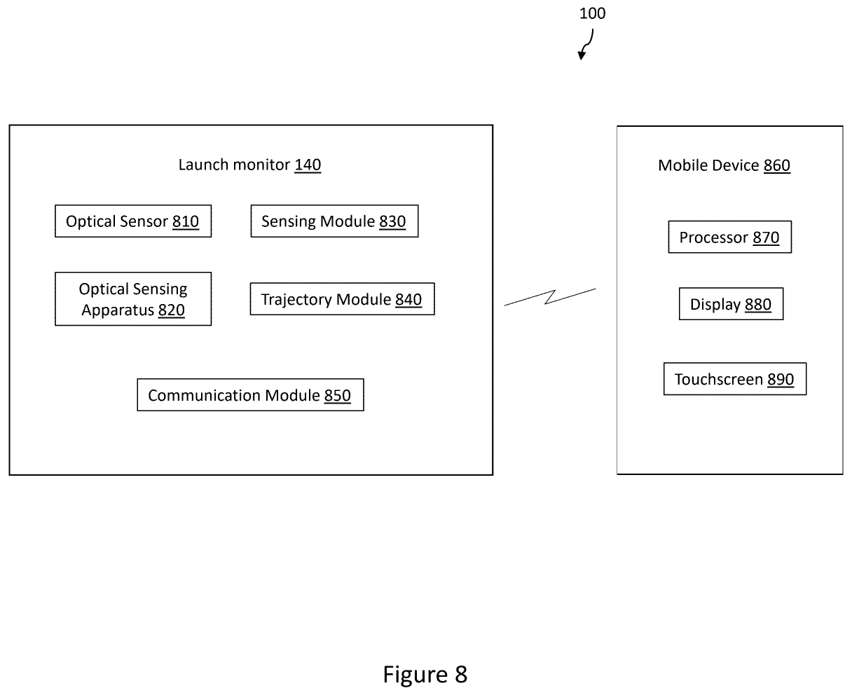

The computed value known as the “D-Plane” helps explain the ball flight. The D-Plane provides a comprehensive model for understanding spin and ball flight. It is a model for understanding the starting direction, spin values, and lift due to the Magnus force. Like the other motion parameters 150, D-plane can be used as a predictor for Club Path and Face to Path. In the example shown in FIG. 1, some or all of the motion parameters 150 are received by a regression analysis module 170 (which may for example be part of a trajectory module as shown in FIG. 8), which outputs curve-fitted values of Club Path 180 and Face to Path 190, as described below.

It is noted that block diagrams are provided herein for exemplary purposes; a person of ordinary skill in the art will recognize myriad variations that nonetheless fall within the scope of the present disclosure. For example, block diagrams may show a particular arrangement of components, modules, services, steps, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein.

Before continuing, it should be noted that the examples described above are provided for purposes of illustration, and are not intended to be limiting. Other devices and/or device configurations may be utilized to carry out the operations described herein.

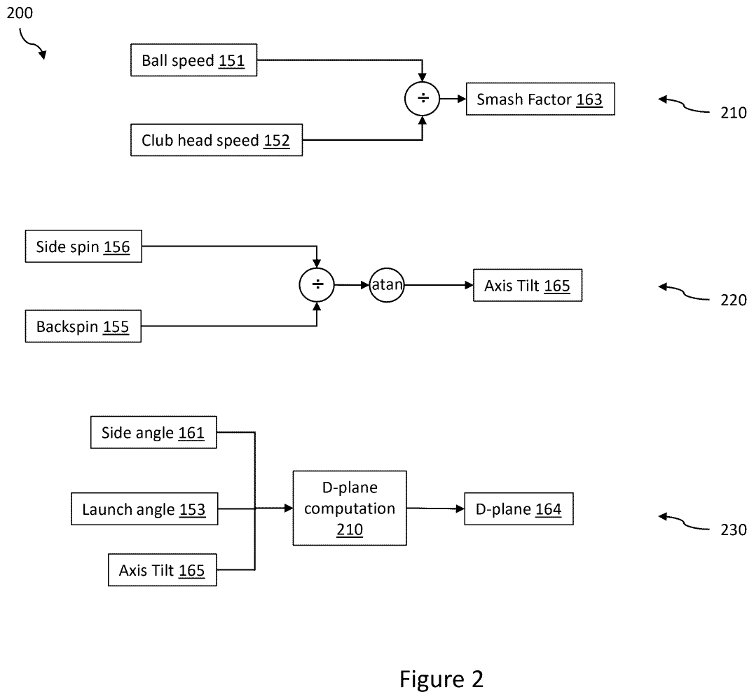

FIG. 2 is a schematic, diagrammatic representation, in flow diagram form, of at least a portion of an example club path measurement method 200, in accordance with at least one embodiment of the present disclosure. It is understood that the steps of method 200 may be performed in a different order than shown in FIG. 2, additional steps can be provided before, during, and after the steps, and/or some of the steps described can be replaced or eliminated in other embodiments. One or more of steps of the method 200 can be carried by one or more devices and/or systems described herein, such as components of the system 100, mobile device 860 (see FIG. 8), and/or processor circuit 950. Some of the motion parameters 150 can be measured directly by the launch monitor 140. However, others (such as the smash factor 163, axis tilt 165 and D-plane 164) may be calculated from measured values, as shown in FIG. 2.

In step 210, the method 200 includes dividing the ball speed 151 by the club head speed 152 to yield the smash factor 163. In some embodiments, the smash factor 163 may be used instead of ball speed 151 and club head speed 152 in the regression analysis module 170, as the smash factor 163 includes the information and correlations of the ball speed 151 and club head speed 152. In other embodiments, all three parameters may be used.

In step 220, the method 200 includes dividing the side spin 156 from the backspin 155, and taking the arctangent of the result, to yield the axis tilt 165 (e.g., in degrees). In some embodiments, the axis tilt 165 may be used instead of side spin 156 and backspin 155 in the regression analysis module 170, as the axis tilt 165 includes the information and correlations of side spin 156 and backspin 155. In other embodiments, all three parameters may be used.

In step 230, the method 200 includes performing a D-plane computation 210 on the side angle 161, launch angle 153, and axis tilt 165, to yield the D-plane 164.

Mathematically, the D-Plane is derived from Side Angle, Launch Angle, and Axis Tilt, where Axis Tilt is atan (side spin/backspin). The following is an example MATLAB code snippet that can be used to compute D-Plane.

theta=90−SideAngle;

phi=90−LaunchAngle;

x=cos((pi/180).*theta).*sin((pi/180).*phi);

y=sin((pi/180).*theta).*sin((pi/180).*phi);

z=cos((pi/180).*phi);

xPrime=z.*tan((pi/180).*−AxisTilt);

newX=x+xPrime;

DPlane=(180/pi).*atan(newX./y)

In some embodiments, D-plane may be used by the regression analysis module 170 in place of side spin 156, backspin 155, axis tilt 165, side angle 161, and launch angle 153, as D-plane includes the information and correlations of these parameters. In other embodiments, all six parameters, or combinations thereof, may be used. As with other motion parameters, D-plane can be used to simulate the trajectory of the ball once it is struck, and/or to inform and educate the golfer about their swing.

It is noted that flow diagrams are provided herein for exemplary purposes; a person of ordinary skill in the art will recognize myriad variations that nonetheless fall within the scope of the present disclosure. For example, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein.

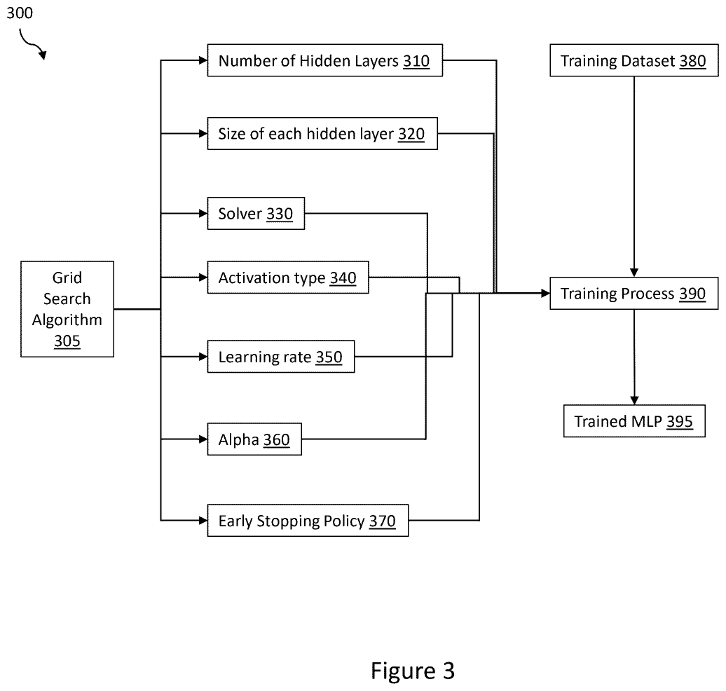

FIG. 3 is a schematic, diagrammatic representation, in block diagram form, of an example regression analysis training process 300, in accordance with at least one embodiment of the present disclosure.

As noted, it is possible, using all the above flight data, to predict the Club Path and Face to Path by performing regression analysis. To find the best regression model for predicting Club Path and Face to Path, several well-documented methods were attempted. These include:
HuberRegressor
LinearRegression
Ridge
RidgeCV
RANSACRegressor
TheilSenRegressor
BayesianRidge
RidgeCV
NuSVC
SVR (three varieties)
GradientBoostingRegressor (XGB)
MultiLayer Perceptron (MLP)

Each of these regression techniques was applied to a large set of recorded golf swings, each swing containing known (e.g., directly measured) Club Path and Face to Path values. The recorded swings were collected for the following club types:
1. Driver
2. Fairway Metal/Hybrid
3. Iron
4. Wedge

For example, the irons dataset contained over 1,900 recorded swings. The Root Mean Square Error (RMSE) for predicting Face to Path follows for each regression model:
Huber RMSE=2.079
Linear RMSE=1.858
Ridge RMSE=1.858
RidgeCV RMSE=1.858
RANSAC RMSE=3.605
TheilSen RMSE=3.022
Bayesian RMSE=1.880
Ridge RMSE=1.858
NuSVC RMSE=1.892
RbfSVR RMSE=2.000
PolySVR RMSE=2.361
SigmoidSVR RMSE=31.070
XGB RMSE=1.40

While XGB produced the best overall correlation, the model proved to be too difficult to implement on the intended target devices. Therefore, the multi-layer perceptron (MLP) model was chosen, as it requires less computational overhead and produces similar results to XGB. There are several parameters for an MLP model, such as the number of hidden layers, size of each hidden layer, solver, activation and learning rate. Using the Grid Search algorithm for selecting the optimal parameters, the following values were used:
hidden_layer_sizes=(64,64,16)
activation=relu
alpha=01
learning_rate=invscaling
solver=adam
early_stopping=true

FIG. 3 is a representation of this process, wherein the grid search algorithm 305 is used to determine the number of hidden layers 310, the size of each hidden layer 320, the solver 330 that will be used, the activation type 340, the learning rate 350, the alpha value 360, and the early stopping policy 370, in a process that will be familiar to a person of ordinary skill in the art.

These parameters are then used in a training process 390, which receives the training dataset 380 (e.g., a plurality of golf swing data for each of a plurality of club types) and iteratively converges to a trained model 395, such as a trained multi-layer perceptron (MLP), although other types of regression models may be used instead or in addition.

Using a regression model allows for the challenging Club Path and Face to Path values to be accurately estimated when direct measurements are not available, and even when parameters are not available that lend themselves to closed-form calculation of the Club Path and Face to Path. The present disclosure advantageously leverages non-obvious correlations between seemingly unrelated parameters, to enable calculation of otherwise-unavailable data such as Club Path and Face to Path using only the data already available from the flight monitor 140.

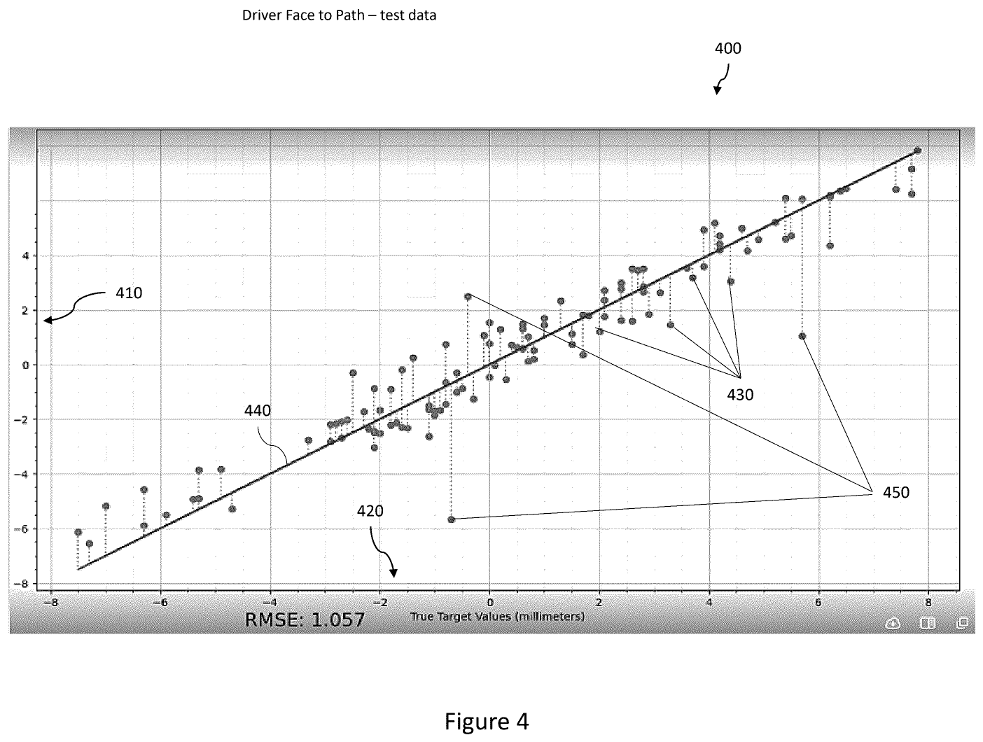

FIG. 4 is a graph 400 showing measured values of Face to Path on the X-axis 420 vs. values predicted by the trained regression algorithm on the Y-axis 410 for a driver type club, in accordance with at least one embodiment of the present disclosure. Visible are a plurality of data points 430 (e.g., one data point for every swing in the “driver” dataset) that fall along a regression curve 440. In the example shown in FIG. 4, the regression curve 440 is a straight line, although this may not always be the case. FIG. 4 shows that, with only a small number of outliers 450, the regression algorithm consistently predicts the Face to Path values to within 2 degrees or less.

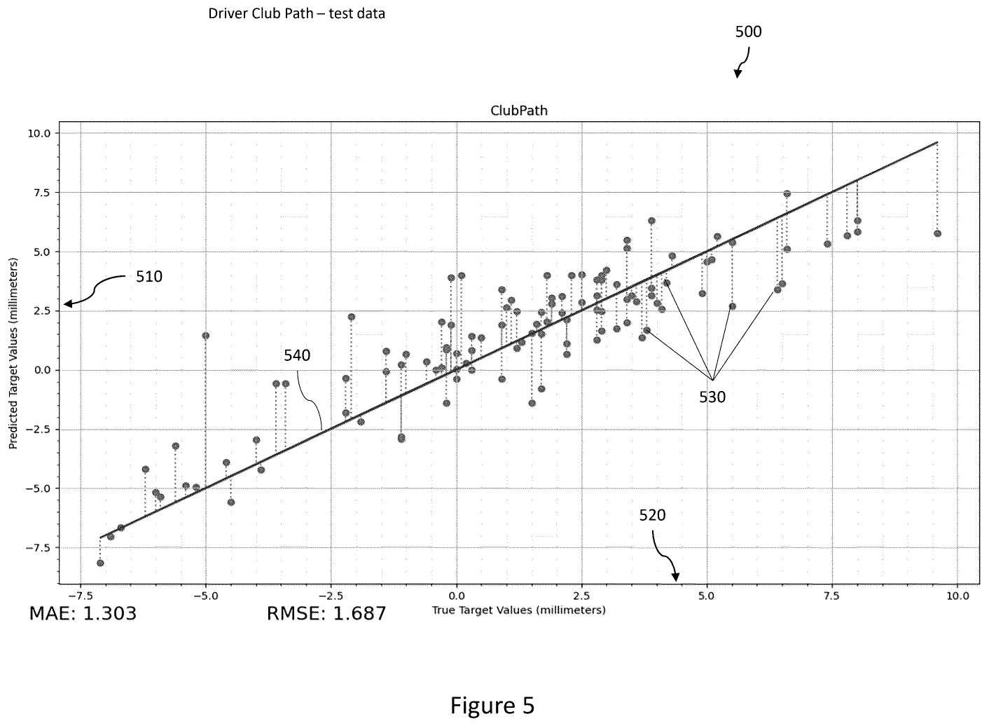

FIG. 5 is a graph 500 showing measured values of Club Path on the X-axis 520 vs. values predicted by the trained regression algorithm on the Y-axis 510 for a driver type club, in accordance with at least one embodiment of the present disclosure. Visible are a plurality of data points 530 (e.g., one data point for every swing in the “driver” dataset) that fall along a regression curve 540. In the example shown in FIG. 5, the regression curve 440 is a straight line, although this may not always be the case. FIG. 5 shows that, with only a small number of outliers, the regression algorithm consistently predicts the Club Path values to within 4 degrees or less.

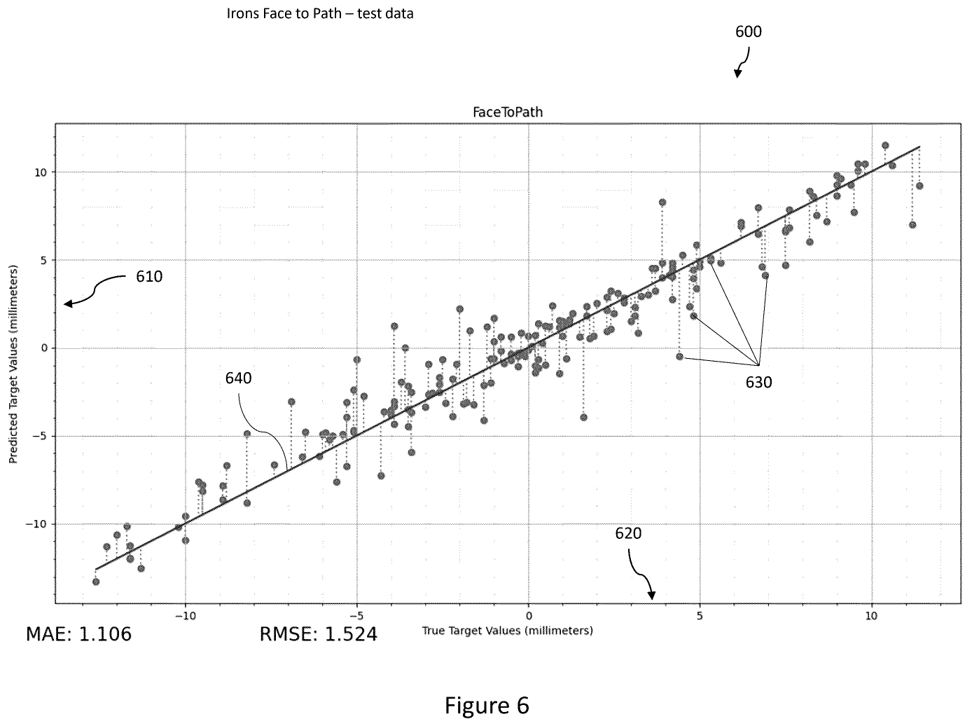

FIG. 6 is a graph 600 showing measured values of Face to Path on the X-axis 620 vs. values predicted by the trained regression algorithm on the Y-axis 610 for an iron type club, in accordance with at least one embodiment of the present disclosure. Visible are a plurality of data points 630 (e.g., one data point for every swing in the “irons” dataset) that fall along a regression curve 640. In the example shown in FIG. 6, the regression curve 640 is a straight line, although this may not always be the case. FIG. 6 shows that, with only a small number of outliers, the regression algorithm consistently predicts the Face to Path values to within 2 degrees or less.

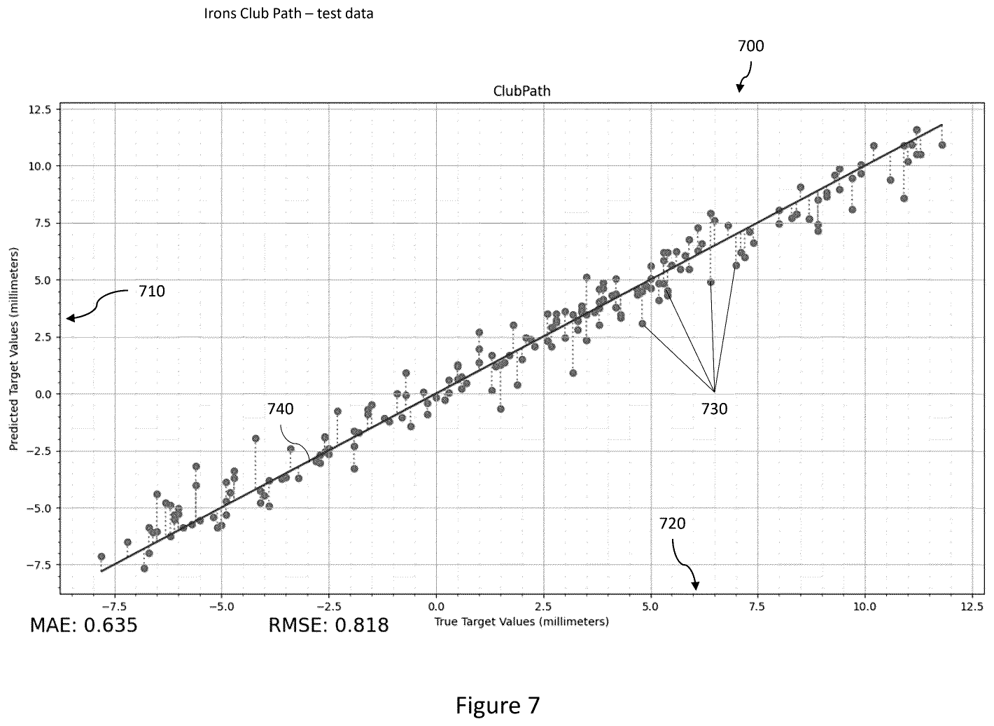

FIG. 7 is a graph 700 showing measured values of Club Path on the X-axis 720 vs. values predicted by the trained regression algorithm on the Y-axis 710 for an iron type club, in accordance with at least one embodiment of the present disclosure. Visible are a plurality of data points 730 (e.g., one data point for every swing in the “driver” dataset) that fall along a regression curve 740. In the example shown in FIG. 7, the regression curve 740 is a straight line, although this may not always be the case. FIG. 7 shows that, with only a small number of outliers, the regression algorithm consistently predicts the Face to Path values to within 2 degrees or less.

FIG. 8 is a schematic, diagrammatic representation, in block diagram form, of at least a portion of an example club path measurement system 100, in accordance with at least one embodiment of the present disclosure. The launch monitor 140 includes an optical sensor 810, optical sensing apparatus 820, sensing module 830, trajectory module 840, and communication module 850. Depending on the implementation, some motion parameters 150 (such as the ball speed 151 and club head speed 152) may be directly measured by the sensing module 830, while others (such as the smash factor 163, D-plane 164, and axis tilt 165) may be computed, derived, or estimated by the trajectory module 840.

In some embodiments, the launch monitor 140 is in wired or wireless communication with a mobile device 860 (e.g., via the communication module 850). The mobile device 860 may for example be a smartphone, tablet, phablet, smart glasses, smart watch, notebook, laptop, or other computing device. The mobile device 860 includes a processor 870, display 880, and touchscreen 890. Depending on the implementation, the touchscreen 890 may be used to control certain aspects of the flight monitor 140, and the display 880 may be used to display outputs of the launch monitor 140, such as the computed Club Path and Face to Path values. Depending on the implementation, the regression analysis module 170 may execute in the trajectory module 840, the mobile device 860, or combinations thereof.

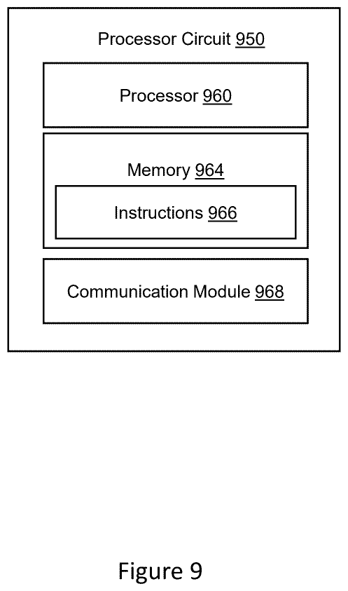

FIG. 9 is a schematic diagram of a processor circuit 950, in accordance with at least one embodiment of the present disclosure. The processor circuit 950 may be implemented in the system 100, or other devices or workstations (e.g., third-party workstations, network routers, etc.), or on a cloud processor or other remote processing unit, as necessary to implement the method. As shown, the processor circuit 950 may include a processor 960, a memory 964, and a communication module 968. These elements may be in direct or indirect communication with each other, for example via one or more buses.

The processor 960 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 960 may also comprise another hardware device, a firmware device, or any combination thereof configured to perform the operations described herein. The processor 960 may also be implemented as a combination of computing devices, e.g., a combination of a DSP and a microprocessor, a plurality of microprocessors, one or more microprocessors in conjunction with a DSP core, or any other such configuration.

The memory 964 may include a cache memory (e.g., a cache memory of the processor 960), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 964 includes a non-transitory computer-readable medium. The memory 964 may store instructions 966. The instructions 966 may include instructions that, when executed by the processor 960, cause the processor 960 to perform the operations described herein. Instructions 966 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 968 can include any electronic circuitry and/or logic circuitry to facilitate direct or indirect communication of data between the processor circuit 950, and other processors or devices. In that regard, the communication module 968 can be an input/output (I/O) device. In some instances, the communication module 968 facilitates direct or indirect communication between various elements of the processor circuit 950 and/or the system 100. The communication module 968 may communicate within the processor circuit 950 through numerous methods or protocols. Serial communication protocols may include but are not limited to United States Serial Protocol Interface (US SPI), Inter-Integrated Circuit (I2C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, or readings from the flight monitor or its sensors) may be accomplished using any suitable wireless or wired communication technology, such as a cable interface such as a universal serial bus (USB), micro USB, Lightning, or Fire Wire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

As will be readily appreciated by those having ordinary skill in the art after becoming familiar with the teachings herein, directly measuring Club Path and Face to Path presents significant difficulties, as does accurately measuring other parameters from which Club Path and Face to Path can be computed using closed-form equations. Accordingly, it can be seen that the club path measurement system fills a long-standing need in the art, by using numerical/statistical methods to deduce the Club Path and Face to Path from other, more readily available data.

A number of variations are possible on the examples and embodiments described above. For example, other motion parameters may be used, instead of or in addition to those described herein. Furthermore, the same numerical/statistical principles can be used to deduce not only Club Path and Face to Path, but other motion parameters as well, including those described herein, and otherwise, based on whatever data may be available from the flight monitor.

The technology described herein may be applied to sports other than golf, including any sport where an instrument strikes a sport object, including but not limited to tennis, badminton, racquetball, squash, croquet, baseball, softball, etc. Furthermore, the technology can be applied to non-sporting applications where an instrument strikes an object. In some implementations, the flight monitor and the mobile device may be the same device.

Accordingly, the logical operations making up the embodiments of the technology described herein are referred to variously as operations, steps, objects, elements, components, or modules. Furthermore, it should be understood that these may occur or be performed or arranged in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the club path measurement system. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the club path measurement system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A system for predicting at least one of a club path, face to path or face to target of a golf club during a golf swing comprising:
a sensing module executing code and configured to:
determine launch characteristics of a sport object upon being launched by the golf club; and
a trajectory module executing code and configured to:
record a plurality of golf swings, comprising at least a known club path, face to path and face to target value; and
predict at least one of the club path, the face to path or the face to target of the golf swing based on launch characteristics and recorded plurality of golf swings.

2. The system of claim 1, wherein the trajectory module calculates a D-plane for the golf club based on the launch characteristics.

3. The system of claim 2, wherein a trajectory for the sport object is determined based on the launch characteristics and the D-plane.

4. The system of claim 1, further comprising:
a launch monitor, the launch monitor providing images of the sport object to the sensing module.

5. The system of claim 4, wherein the launch monitor includes an optical sensor and does not include a radar.

6. The system of claim 5, wherein the launch characteristics are determined with an optical sensing apparatus of the sensing module that is operatively coupled to the optical sensor.

7. The system of claim 4, wherein the sport object is a golf ball.

8. The system of claim 1, wherein the recorded plurality of golf swings further comprises a plurality of golf club types.

9. The system of claim 8, wherein the plurality of golf club types comprises a driver, a fairway metal or hybrid, an iron, and a wedge.

10. The system of claim 1, wherein the launch characteristics include at least one of:
Ball Speed;
Club Head Speed;
Launch Angle;
Total Spin;
Backspin;
Side Spin;
Carry;
Total Distance;
Offline;
Descent Angle;
Side Angle (azimuth);
Peak Height; or
Smash Factor.

11. A method for predicting at least one of a club path, a face to path or a face to target of a golf club during a golf swing, the method comprising:
determining launch characteristics of a sport object upon being launched;
recording a plurality of golf swings, comprising at least a known club path, face to path and a face to target value; and
predicting at least one of the club path, the face to path, or the face to target of the golf swing based on launch characteristics and recorded plurality of golf swings.

12. The method of claim 11, further comprising, with a trajectory module, calculating a D-plane for the golf club that struck the sport object based on the launch characteristics.

13. The method of claim 12, further comprising, with the trajectory module, determining a trajectory for the sport object based on the launch characteristics and the D-plane.

14. The method of claim 11, further comprising:
with a launch monitor, providing images of the sport object to a sensing module, wherein the launch monitor includes an optical sensor and does not include radar.

15. The method of claim 14, wherein an optical sensing apparatus determines the launch characteristics.

16. The method of claim 11, wherein the sport object is a golf ball.

17. The method of claim 11, wherein the recorded plurality of golf swings further comprises a plurality of golf club types.

18. The method of claim 17, wherein the plurality of golf club types comprises a driver, a fairway metal or hybrid, an iron, and a wedge.

19. The method of claim 11, wherein the launch characteristics include at least one of:
Ball Speed;
Club Head Speed;
Launch Angle;
Total Spin;
Backspin;
Side Spin;
Carry;
Total Distance;
Offline;
Descent Angle;
Side Angle (azimuth);
Peak Height; or
Smash Factor.

20. A non-transitory computer-readable storage medium storing instructions, which when executed by at least one processor of a computer system, causes a computer system to carry out the method of claim 11.
